(19) United States
(12) Patent Application Publication
(10) Pub. No.: US 2024/0007402 A1
(43) Pub. Date: Jan. 4, 2024

(54) DIGITAL TWINNING OF LARGE-SCALE NETWORKS

(71) Applicant: Bank of America Corporation, Charlotte, NC (US)

(72) Inventor: Kevin A. Delson, Woodland Hills, CA (US)

(21) Appl. No.: 17/852,688

(22) Filed: Jun. 29, 2022

(51) Int. Cl. H04L 47/122; H04L 47/11; H04L 45/02; H04L 43/10

(52) U.S. Cl. CPC H04L 47/122; H04L 47/11; H04L 45/08; H04L 43/10

(57) ABSTRACT

A system is provided that traces and records data elements in transit on a network. Based on the tracing, the system may generate a map of the network topology and data flow within the network. The system may identify bottlenecks and other anomalous data flows within the network. The system may generate a digital twin of the network. The digital twin may be generated based on the network topology map and data flow within the network. Within the digital twin, the system may simulate changes to the network that may alleviate a bottleneck or other anomalous data flow.

### FIELD OF TECHNOLOGY

This application describes apparatus and methods for creating a digital twin of large-scale networks and using the digital twin to improve the flow of data within the network.

### BACKGROUND

Large enterprise organizations may employ over 750,000 members. Such large enterprise organizations may utilize over 4,000 different software applications. Access to the different software applications may be controlled by a network of over 4,500 different computer servers. The large number of members, software applications and computer servers give rise to complex network environments.

The integration of diverse systems may cause unintended routing paths. Such unintended routing paths may be inefficiently circuitous and consume disproportionate bandwidth of the network. The unintended routing paths may delay delivery of data to a destination. The delay may negatively impact operation of downstream systems that are awaiting delivery of data carried by the network. The unintended routing paths may also cause network congestion. For example, a node on the network may receive a disproportionate number of requests to forward data to a destination. The disproportionate number requests may create a bottleneck within the network.

Because of the large scale and variety of systems operating within such complex network environments, it is technically challenging to detect and correct such undesirable data flows. Additionally, the technical challenge of tracking data within such a complex network environments is exacerbated for financial institutions that secure sensitive consumer data. Such sensitive consumer data is typically encrypted before being released onto the network. As a result of the encryption, routing systems on the network may not be aware of whether a payload carried by a node is needed by a nearby node or a more distant node.

Accordingly, it would be desirable to provide systems that are capable of detecting unintended routing paths within a complex network environment. It would also be desirable to provide systems that are capable of simulating changes to routing paths within a complex network environment. Finally, it would be desirable to provide systems for eliminating unintended routing paths within a complex network environment. Therefore, it is desirable to provide systems for DIGITAL TWINNING OF LARGE-SCALE NETWORKS.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure;

FIG. 2 shows an illustrative system in accordance with principles of the disclosure;

FIG. 3 shows an illustrative topology and routing paths of a complex network environment;

FIG. 4 shows an illustrative operational scenario in accordance with principles of the disclosure;

FIG. 5 shows illustrative apparatus in accordance with principles of the disclosure;

FIG. 6 shows illustrative information in accordance with principles of the disclosure; and

FIG. 7 shows illustrative information in accordance with principles of the disclosure.

### DETAILED DESCRIPTION

A system is provided that traces data elements in transit in a complex network environment. A complex network is a set of nodes with connections between them, called edges. In complex networks, nodes and edges linking nodes may evolve as part of the dynamics of interactions between the nodes. The structure (e.g., topology) of a complex network may depend on the flow of data through the network.

An edge linking two nodes may be “directed” if the edge runs in only one direction and undirected if it is bidirectional. The number of edges connected to a node may be referred to as a degree of a node. A network path may include two or more nodes and two or more edges. A geodesic network path may refer to the shortest path through the network from one node to another. There may be more than one geodesic network path between two nodes. The diameter of a network may refer to the length (in number of edges) of the longest geodesic network path between any two nodes.

Conventionally, it may have been possible to “eyeball” a layout of a network to gain an understanding of which nodes are communicating with each other. However, for complex networks that include thousands of nodes and millions of edges, however, this approach is useless. A human cannot perform a meaningful assessment of or of a million edges, even with the assistance of modern computer rendering tools.

Unconventional computational tools are needed to ascertain a topology of a complex network and model behavior of the complex network. Additionally, unconventional computational tools are needed to understand the meaning of detected properties of complex networks. Unconventional computational tools are also needed to determine how to implement changes on a complex network and the impact of any such changes.

Such unconventional computational tools may implement an artificial intelligence (“AI”) method for dynamically rerouting network traffic on a network. The AI method may include extracting computer readable instructions stored on a non-transitory medium. The method may include executing the computer readable instructions on a processor of a computer system. Execution of the computer readable instructions by the processor may implement one or more steps of the AI method.

Electronic information, such as text, audio, images, or video may be broken down into data packets. Each data packet may be transmitted from a source node to a destination node. The electronic information, such as an audio file or image, may be reassembled at the destination node based on the data packets received from the source node.

A data packet may refer to a unit of data that travels along a given network path. A data packet may include a header section and a payload section. The header section typically stores information about the packet (e.g., sequence number) and a service used to transmit the packet. The payload section includes the underlying data being transmitted on the network.

The AI method may include tracing a data packet or other data element transmitted within a complex network. The tracing may determine a flow of data in the complex network. The flow may identify bottlenecks and other undesirable data flows within the complex network. The AI method may detect a bottleneck by identifying a target node on the network that routes a threshold number of data packets within a threshold time window. An exemplary undesirable data flow may include transmitting data that originates in California to a Virginia data center for processing when a closer data center in Texas is available for processing the data.

The AI method may include detecting a threshold transmission latency on the complex network. Latency may refer to a time delay before a destination node receives data transmitted by a source node. The AI method may include increasing traffic on the complex network by activating tracing of the data packet. Based on the tracing, the AI method may include identifying a bottleneck within the complex network. In response to detecting the bottleneck, the AI method may include simulating a change to the network.

The change may be structured to alleviate the bottleneck. For example, the change may include requiring a node to route data packets to a target node. Based on the simulated change, the AI method may implement the change on the network. Implementing the change on the network may include reprogramming a routing protocol of one or more nodes on the complex network.

The AI method may detect the threshold transmission latency by determining a final destination of a first data packet generated by an edge node on the network. An edge node may refer to a computer system that provides an interface for communicating with nodes part of a complex network and other systems outside the network. The edge node may run administrative software tools for managing the complex network.

The AI method may include determining a geodesic network path from the edge node to an internal node. The AI method may include determining a geodesic network path from the edge node to a final destination. The AI method may include determining, based on data packet tracing deployed on the network, whether the first data packet is being routed along the geodesic network path.

In response to detecting that the first data packet is not being routed along the geodesic network path, the AI method may include imposing a fixed routing pathway for a second data packet generated by the edge node such that the second data packet is transmitted along the geodesic network path.

The AI method may apply a change to the network. The change may include configuring a routing table for a threshold number of nodes on the network. A routing table may include routing destinations for data packets received by a node. When the node receives a data packet, the node references the routing table to determine a destination node for the received data packet. The routing table may include information on how far each destination is from the node.

A routing table may not include a list of all possible node destinations. Rather, the routing table may include node destinations that are within a threshold distance of the node. The threshold distance may be defined based on a geographic distance between a node and a destination node. The threshold distance may be defined based on a number of edges between a node and a destination node.

The change may include reconfiguring the routing table for a threshold number of nodes that are positioned within a threshold distance of a target node. The reconfiguring of the routing table may cause the threshold number of nodes to bypass the target node when transmitting data packets. Bypassing the target node may relieve data congestion at or near the target node.

The AI method may include simulating a change to the complex network by simulating a bypass of the target node in a digital twin environment. A digital twin may refer to a virtual representation of a complex network. The digital twin may be generated based on the tracing of one or more data packets. The digital twin may be updated from real-time tracing data. The digital twin may be generated by applying machine learning algorithms to the tracing data.

Machine learning algorithms may identify patterns in traced data and make decisions about how to change a network based on the detected patterns. Machine learning algorithms improve over time because the algorithms are programmed to learn from previous decisions. An illustrative machine learning algorithm may include AdaBoost, Naive Bayes, Support Vector Machine and Random Forests. An illustrative machine learning algorithm may include a neural network such as Artificial Neural Networks and Convolutional Neural Networks.

Generally, a neural network implements machine learning by passing an input through a network of neurons—called layers—and providing an output. The more layers of neurons that are included in the neural network, the “deeper” the neural network. A neural network learns from outputs flagged as erroneous and adapts its neuron connections such that the next time the neural network receives a particular input it generates a more relevant output.

To effectively provide relevant outputs, a neural network must first be trained by analyzing training data sets. Neural networks learn from the training data sets and rearrange interconnection between layers of the network in response to processing the training data. The strength or weight of a connection between layers of the neural network can vary. A connection between two or more layers can be strong, weak or anywhere in between. A neural network may self-adapt by adjusting the strength of the connections among its layers to generate more accurate outputs.

The AI method may include activating data tracing by inserting an executable header into a target data packet. An executable header may include instructions that are executable by a node that routes the target data packet. The executable header may transmit a homing signal from each node on the network that routes the target data packet.

The machine learning algorithms may construct digital representations of nodes and edges of a complex network. Simulating changes to the complex network may include machine learning models that alter the number of nodes, edges connecting nodes of the complex network. The simulated changes to the network may include altering data flow paths through the network, changing network hardware and changing configuration settings of network hardware.

Based on the packet tracing, the AI method may detect a hard-coded circuitous routing path. For example, a program or system deployed on the complex network may require that a first node transmit data to a second node via a third node. The AI method may include, within the digital twin, simulating the impact of deleting the hard-coded circuitous routing path. The AI method may include, within the digital twin, simulating the impact of changing the hard-coded circuitous routing path.

Based on the simulating the AI method may include deleting or changing the hard-coded circuitous routing path. Deleting or changing the hard-coded circuitous routing path may allow data packets to travel along a geodesic network path from the first node to the second node.

In some embodiments, the AI method may include imposing a hard-coded routing path that must be followed by data flowing between two nodes. For example, to relieve a bottleneck, the AI method may impose a hard-coded routing path that avoids a target node. The hard-coded routing path may be longer than a geodesic network path from the first node to the second node. However, relieving the bottleneck at the target node may have a greater effect on reducing latency than utilizing the geodesic network path.

The AI method may include simulating adding hardware resources to the complex network. The additional hardware resources may relieve a bottleneck. The additional hardware resources may allow a node to route more data packets within a predetermined amount of time. Illustrative network hardware that may be added to improve network performance may include hubs, switches, routers, bridges, gateways, modems, repeaters or access points.

The AI simulator may simulate hardware or configuration changes within a digital twin of the complex network to determine an impact on network performance. An exemplary hardware change may include replacing switches with hubs. Hubs send data to all nodes that are connected to them. Switches send data only to target node. If a hub is connected to three nodes, a switch will typically be three times faster than that hub. If tens of nodes are connected to a hub, then replacing the hubs with switches will improve network performance.

The AI simulator may detect that too many nodes are connected to a router than the router can handle. Having too many nodes connection to a router may cause a bottleneck. The AI simulator may determine that network performance can be improved by upgrading the router or replacing the router with a switch.

The AI simulator may detect that the network includes subnets that are each connected to each other with a router. The AI simulator may determine that reducing the number of subnets may improve network performance. For example, the numerous routers needed to connect each of the subnets may cause an increase the number of edges data must travel through to get to a final destination node. The AI simulator simulate whether network performance can be improved by replacing the multiple routers with a single upgraded router.

The AI method may include simulate a change in configuration settings of network hardware. Illustrative configuration changes may include changing data flow from point-to-point to multicast. Simulating the configuration changes may determine whether include determining whether allowing higher priority data to flow faster than lower priority data improves overall network performance.

The AI simulator may determine whether a complex network includes single failure points. A single failure point may occur when there is just one edge linking network components. The AI simulator may test whether if a nodes fails, can data traffic be rerouted around the failed node. The AI simulator may determine a revised network topology that reduces or eliminates a single failure point.

An artificial intelligence (“AI”) network traffic simulator is provided. The AI simulator may include computer executable instructions. The computer executable instructions, when executed by a processor on a computer system may implement functionality of the AI simulator.

The AI simulator may detect a threshold transmission latency on a complex network. The AI simulator may increase network traffic by activating data packet tracing on the complex network. Increasing the network traffic may temporarily increase the threshold transmission latency. Based on the data packet tracing, the AI simulator may detect a circuitous data flow within the network. A circuitous data flow may be a routing path of a data packet that is longer than the geodesic network path to a destination.

In response to detecting the circuitous data flow, the AI simulator may simulate a change to the network. The change may alleviate the circuitous data flow. The change may include adding additional routing nodes to the network. The change may include mandating that target nodes following predetermined routing procedures. The predetermined routing procedures may include forward received data packets to a target destination. The predetermined routing procedures may be defined in a routing table stored on a node.

Based on the expected impact of the simulated change, the AI simulator may apply the change on the complex network. Applying the simulated change to the complex network may reduce the threshold transmission latency and eliminate circuitous data pathways.

A circuitous data flow may occur when a first intermediary node routes data packets generated by a target node. The first intermediary node may be geographically further away from the target node than a second intermediary node that is capable of routing the data packets generated by the target node. The change to the network forces simulated and implemented by the AI simulator may force the second intermediary node to route data packets generated by the target node. The AI simulator may change a routing table of the target node to force the target node to utilize the second intermediary node when forwarding data packets.

The AI simulator may build a digital twin of the complex network. The AI simulator may utilize machine learning algorithms to build the digital twin. The AI simulator may build the digital twin using the information obtained from tracing data travelling on the complex network.

Within the digital twin, the AI simulator may simulate a change to the network. The AI simulator may simulate a change that is expected to alleviate a detected circuitous data flow. The AI simulator may observe an impact of the change within the digital twin. Based on a response of the digital twin to the simulated change, the AI simulator may deploy the change on the complex network. Deploying the change may include changing a routing configuration setting of at least one edge node on the network. The AI simulator may change the routing configuration of a complex network by changing routing tables stored on one or more nodes.

To perform tracing of data packets on the network, the AI simulator may decrypt a target data packet at each node that transmits the target data packet. For example, the complex network may carry sensitive consumer data. Sensitive consumer data may be encrypted before being released onto the complex network. As a result of the encryption, nodes on the complex network may not be aware of whether a payload carried by a data packet is needed by a nearby node or a more distant node.

The AI simulator may examine the decrypted data. The AI simulator may identify, based on examining the decrypted data, a target application that generated the data packet. The AI simulator may identify an edge node that runs the target application that generated the data packet. The AI simulator may determine a final destination node for data packets generated by the target application. The AI simulator may record a location of each intermediary node that routes the target data packet until it reaches the final destination.

Based on the location of each intermediary node, the AI simulator may determine a pathway from a source node to a destination node associated with data packets generated by the target application. The AI simulator may determine whether data packets generated by the target application are following geodesic network pathways through the complex network. The AI simulator may change the routing tables of intermediary nodes that route data packets generated by the target application. The AI simulator may change the routing tables so that data packets generated by the target application follow geodesic network pathways through the complex network or at least follow pathways that have a number of edges within a threshold standard deviation of the geodesic network pathway.

The AI simulator may trace data packets by configuring each node that processes a target data packet to record a node identifier in a header of the target data packet before forwarding the target data packet. After the data packet reaches a final destination, the AI simulator may then examine the header and determine a number of nodes and/or edges in a pathway associated with transmission of the data packet from a source node to a destination node. Based on the pathway, the AI simulator may apply a machine learning algorithm to reduce the number of nodes and/or edges included in the pathway.

An artificial intelligence (“AI”) network traffic simulator is provided. The AI simulator may include computer executable instructions. The computer executable instructions, when executed by a processor on a computer system may implement functionality of the AI simulator.

The AI simulator may trace a flow of data within a complex network. The AI simulator may trace the flow of data by recording information in a header of a target data packet. For example, the AI simulator may record in the header an identifier of a forwarding node on the network that processes the target data packet. The AI simulator may record in the header a timestamp indicating when a node received the target data packet. The AI simulator may record in the header a destination node for a payload carried by the target data packet. Based on the information recorded in the header, the AI simulator may generate a topology map of the complex network.

The AI simulator may trace the flow of data by utilizing a “traceroute” computer program. The traceroute program may report the sequence of nodes that a data packet passes through when traveling between two points. The traceroute program may assume that an edge exists between any two consecutive nodes in the sequence. Accordingly, sampling the flow of multiple data packets provide information needed to generate a topology map of the complex network.

The AI simulator, based on the flow of data, may build a digital twin of the complex network. The AI simulator may employ machine learning algorithms to recursively trace a flow of data within the complex network. The machine learning algorithm may update a digital twin based on the recursive tracing. The AI simulator may determine an impact on data flow through the complex network when a percentage of nodes are removed or repositioned. The AI simulator may determine an impact on data flow through the complex network when a percentage of nodes are hard coded to route data packets along predetermined pathways or node sequences.

The AI simulator may test, within the digital twin, an alternative data routing pathway. The AI simulator may test, within the digital twin, multiple alternative data routing pathways. Based on the simulated impact of the alternative data routing pathway on data flow within the complex network, the AI simulator may configure the network to implement the alternative data routing pathway.

For example, based on the traced flow of data, the AI simulator may determine a first sequence of nodes that process a threshold number of data packets. The AI simulator may generate an alternative data routing pathway that includes a second sequence of nodes. The alternative data routing pathway may force a target data packet to be processed by a first node within a threshold geographic distance of a second node that generated the target data packet.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown and/or described herein. Method embodiments may omit steps shown and/or described in connection with illustrative methods. Method embodiments may include steps that are neither shown nor described in connection with illustrative methods. Illustrative method steps may be combined. For example, an illustrative method may include steps shown in connection with any other illustrative method.

Apparatus may omit features shown and/or described in connection with illustrative apparatus. Apparatus embodiments may include features that are neither shown nor described in connection with illustrative apparatus. Features of illustrative apparatus may be combined. For example, an illustrative apparatus embodiment may include features shown or described in connection with another illustrative apparatus/method embodiment.

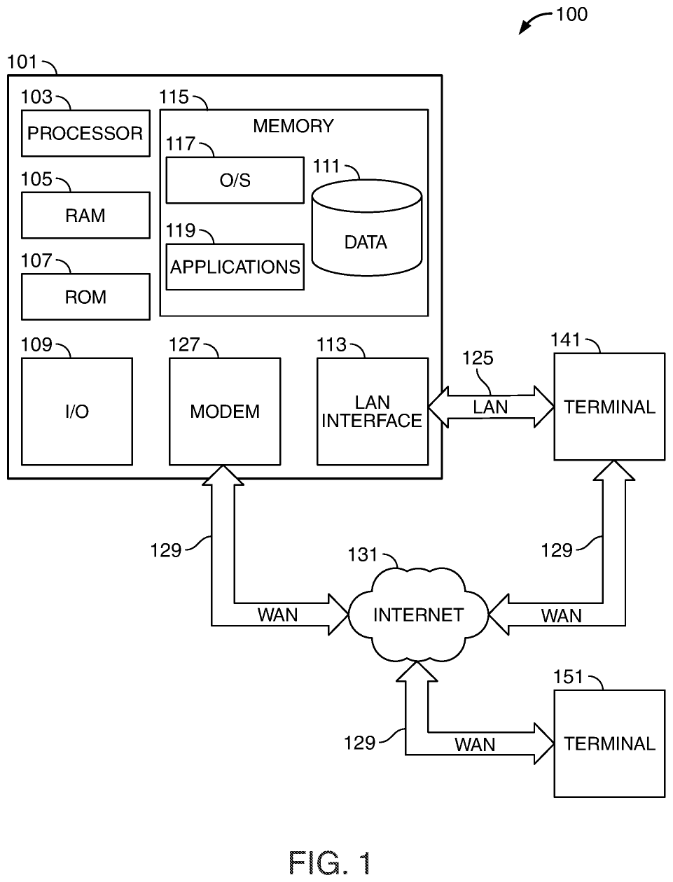

FIG. 1 shows an illustrative block diagram of system 100 that includes node 101. Elements of system 100, including node 101, may be used to implement various aspects of the systems and methods disclosed herein. Each of the systems, methods and algorithms described herein below may include some or all of the elements and apparatus of system 100.

Node 101 may alternatively be referred to herein as a “computer,” “server” or a “computing device.” Node 101 may be a workstation, desktop, laptop, tablet, smartphone, or any other suitable computing device. Node 101 may be a router that receives, analyzes and moves incoming data packets to another node on a network. Node 101 may change the header of a data packet and perform any suitable action relating to moving data packets within a network.

Node 101 may include a processor 103 that controls operation of the device and its associated components, and may include RAM 105, ROM 107, input/output (“I/O”) 109, and a non-transitory or non-volatile memory 115. Machine-readable memory may store information in machine-readable data structures. The processor 103 may also execute software running on node 101. Other components commonly used for computers, such as EEPROM or Flash memory or any other suitable components, may also be part of the node 101.

The memory 115 may be comprised of any suitable permanent storage technology—e.g., a hard drive. The memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory. Any information described in connection with data 111, and any other suitable information, may be stored in memory 115. Node 101 may access data stored on an external database.

I/O module 109 may include connectivity to a microphone, keyboard, touch screen, mouse, and/or stylus through which input may be provided into node 101. The input/output module may also include one or more speakers for providing audio output and a video display device for providing textual, audio, audiovisual, and/or graphical output.

System 100 may be connected to other systems via a local area network (“LAN”) interface 113. System 100 may operate in a networked environment supporting connections to one or more remote computers, such as nodes 141 and 151. Collectively, system 100 and connected nodes may form a complex network. Nodes 141 and 151 may be personal computers, servers or routers that include many or all of the elements described above relative to system 100.

The network connections depicted in FIG. 1 include a LAN 125 and a wide area network (“WAN”) 129 but may also include other networks. When used in a LAN networking environment, node 101 is connected to LAN 125 through LAN interface 113. When used in a WAN networking environment, node 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and system 100 can be operated in a client-server configuration to permit retrieval of data from a web-based server or application programming interface (“API”). Web-based, for the purposes of this application, is to be understood to include a cloud-based system. A web-based node may transmit data to any other suitable nodes. The web-based node may also send computer-readable instructions, together with the data, to any suitable node.

Application program(s) 119 may include computer executable instructions (alternatively referred to as “programs”). The computer executable instructions may be embodied in hardware or firmware (not shown). Node 101 may execute the instructions embodied by the application program(s) 119 to perform various functions. Application program(s) 119 (which may be alternatively referred to herein as “plugins,” “applications,” or “apps”) may include computer executable instructions for implementing smart contracts, participating in a consensus mechanism on a distributed ledger or invoking functionality for any suitable task.

Application program(s) 119 may utilize one or more algorithms that process received executable instructions, perform power management routines or other suitable tasks. Application program(s) 119 may utilize one or more AI systems and models described herein. Application program(s) 119, which may be used by node 101, may include computer executable instructions for invoking functionality related to communication, such as e-mail, Short Message Service (SMS), and voice input and speech recognition applications. Application program(s) 119 may include a “traceroute” computer program for tracing a flow of data on a complex network.

Application program(s) 119 may utilize the computer-executable instructions executed by a processor. Generally, programs include routines, programs, objects, components, data structures, etc., that perform particular tasks or implement particular abstract data types. A node may be operational with distributed computing environments where tasks are performed by remote processing devices that are linked through a communications network. In a distributed computing environment, a program may be located in both local and remote computer storage media including memory storage devices. Nodes may rely on a network of remote servers hosted on the Internet to store, manage, and process data (e.g., “cloud computing” and/or “fog computing”).

Node 101 and/or nodes 141 and 151 may also include various other components, such as a battery, speaker, and/or antennas (not shown). Components of node 101 may be linked by a system bus, wirelessly or by other suitable interconnections. Components of node 101 may be present on one or more circuit boards. In some embodiments, the components may be integrated into a single chip. The chip may be silicon-based.

Node 141 and/or node 151 may be portable devices such as a laptop, cell phone, tablet, smartphone, or any other computing system for receiving, storing, transmitting and/or displaying relevant information. Node 141 and/or node 151 may be one or more user mobile devices. Nodes 141 and 151 may be identical to system 100 or different. The differences may be related to hardware components and/or software components.

This disclosure may be operational with numerous other general purpose or special purpose computing system environments or configurations. Examples of well-known computing systems, environments, and/or configurations that may be suitable for use with this disclosure include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

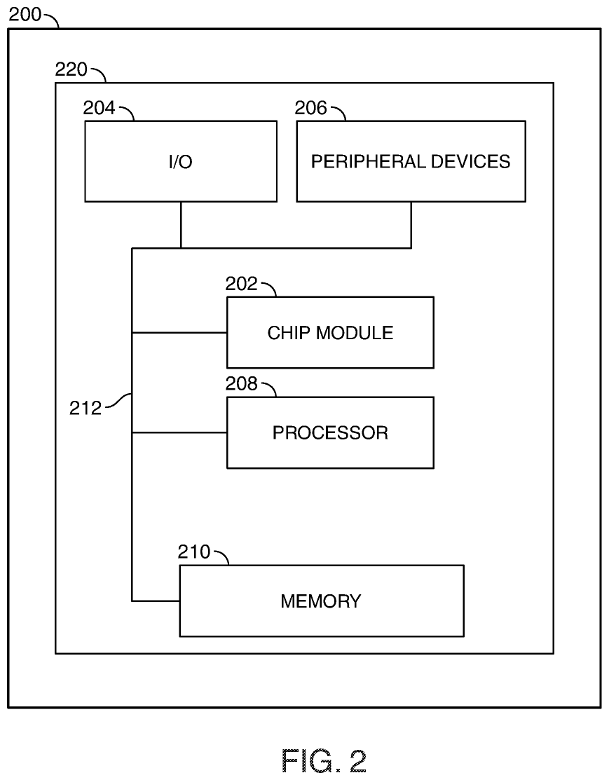

FIG. 2 shows illustrative hardware components 200 that may be utilized in accordance with the principles of the disclosure. Node 101 may include one or more of components 200. Components 200 include chip module 202, which may include one or more integrated circuits. Chip module 202 may be a graphics processing unit (“GPU”) or any other circuitry configured to perform logical operations.

Components 200 include processor 208, which may include one or more integrated circuits which includes logic configured to process executable instructions associated with applications 119. Processor 208 may be a central processing unit (“CPU”) or a GPU. Applications executed by chip module 202 or processor 208 may be stored in machine-readable memory 210.

Components 200 include I/O circuitry 204 which may include a transmitter device and a receiver device. I/O circuitry 204 may interface with fiber optic cable, coaxial cable, telephone lines, wireless devices, PHY layer hardware, a keypad/display control device or any other suitable media or devices. Peripheral devices 206 may include counter timers, real-time timers, power-on reset generators or any other suitable peripheral devices.

Machine-readable memory 210 may be configured to store in machine-readable data structures: machine executable instructions, (which may be alternatively referred to herein as “computer instructions” or “computer code”), applications 119, signals, and/or any other suitable information or data structures.

Components 200 may be coupled together by a system bus or other interconnections 212 and may be present on one or more circuit boards such as circuit board 220. In some embodiments, one or more of components 200 may be integrated into a single chip. The chip may be silicon-based.

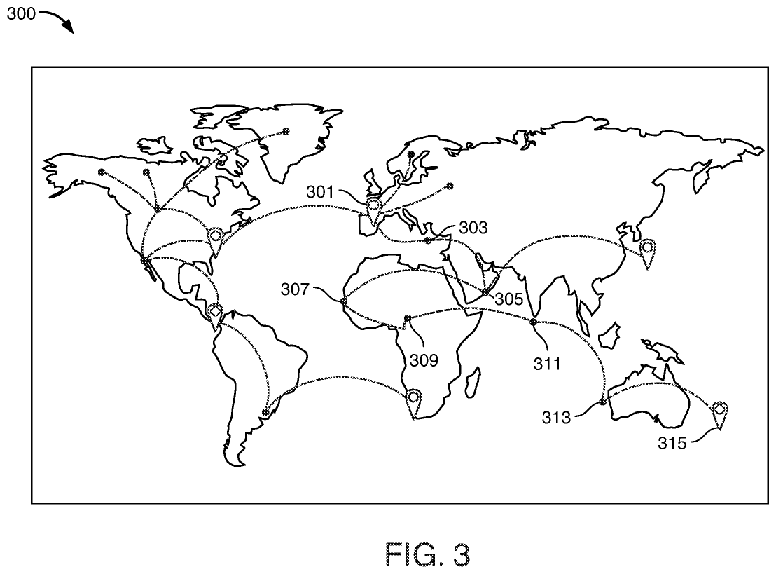

FIG. 3 shows an illustrative topology 300 of a complex network. Topology 300 shows illustrative traces (in broken lines) of data flowing through complex network 300. For example, topology 300 shows an illustrative data path that begins at node 301 and ends at node 315. The illustrative path is defined by the following sequence of eight nodes: 301->303->305->307->309->311->313->315.

Topology 300 also shows that the sequence of eight nodes is not a geodesic network path for transmitting data from node 301 to node 315. For example, topology 300 shows that data may be transmitted from node 305 directly to node 311, bypassing nodes 307 and 309. An AI simulator described herein may trace a data flow through the complex network and identify the illustrative data path that begins at node 301 and ends at node 315. Based on the tracing, the AI simulator may generate topology 300 and construct a digital twin of the complex network.

The AI simulator may also determine that a geodesic network path may be formed if data is transmitted from node 305 directly to node 311. The AI simulator may test, within the digital twin an effect on complex network 300 of transmitting data from node 305 directly to node 311 and bypassing nodes 307 and 309. The AI simulator may reconfigure node 305 to transmit data directly to node 311.

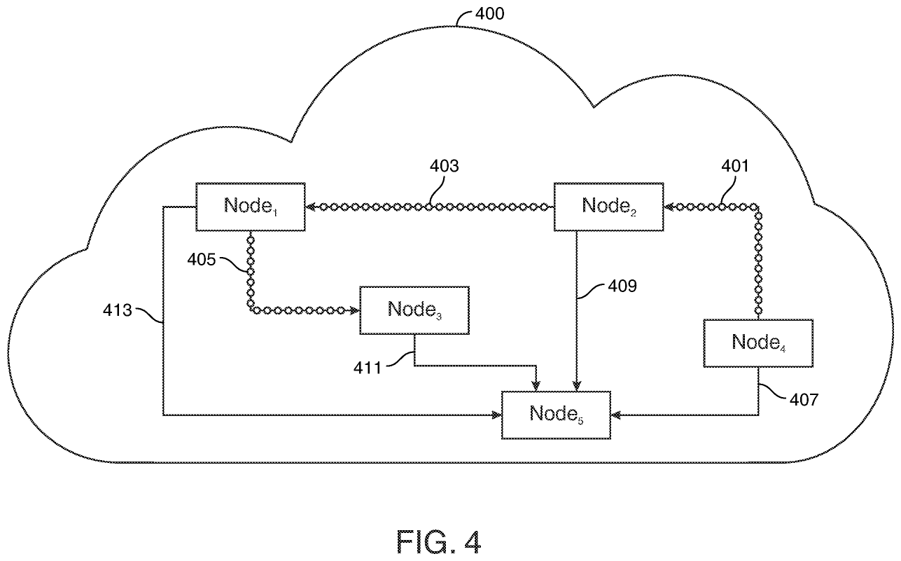

FIG. 4 shows illustrative operation of a traceroute computer program on complex network 400. FIG. 4 shows a pathway (“circle” lines) of data packets transmitted from Node₄ to a final destination at Node₃. FIG. 4 shows that each time a data packet is transmitted by a node along segments 401, 403 or 405 of the pathway, tracing information is transmitted to Nodes. Each node that processes a data packet enroute from Node₄ to Node₃ transmits trace data to Nodes.

Illustrative trace data may include an identifier of an intermediary node (e.g., Node₂ or Node₁) on network 400 that forwards the data packet along segments 401, 403 or 405. The trace data may include a timestamp indicating when an intermediary node received the data packet. Transmission paths 407, 409, 411 and 413 shows illustrative trace data being provided to Nodes. Based on the trace data received by Nodes, an AI simulator may derive a sequence of network nodes that a data packet passes through when traveling between Node₄ and Node₃. Based on the trace data received by Nodes, an AI simulator may derive generate a topology map and associated data flows (e.g., shown in FIG. 3) within a complex network.

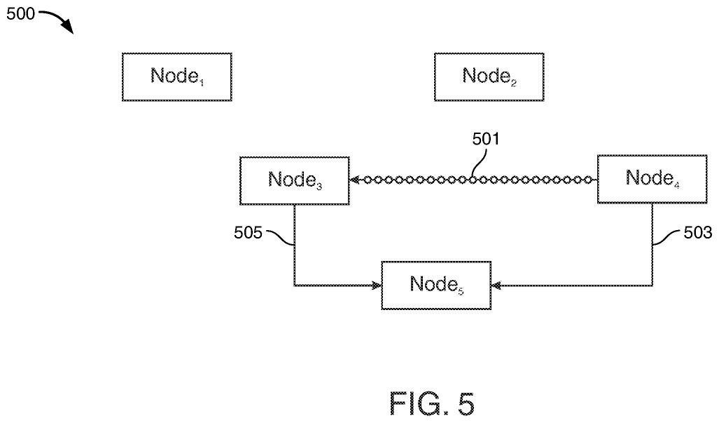

The AI simulator may generate a digital twin of complex network 400 based on the generated topology map and associated data flows. FIG. 5 shows an illustrative digital twin 500 of complex network 400. Based on the trace data stored, the AI simulator may also determine that a geodesic network path may be formed if data received by Node₄ is transmitted directly to Node₃. The AI simulator may test, within digital twin 500 an effect on complex network 400 of transmitting data from Node₄ directly to Nodes and bypassing Node₂ and Node₁.

Based on the simulations, the AI simulator may reconfigure Node₄ to transmit data directly to Node₃. For example, the AI simulator may change a routing table stored on Node₄. The changes to the routing table may instruct Node₄ to transmit data directly to Node₃. The changes to the routing table may instruct Node₄ to transmit a percentage of data directly to Node₃. The AI simulator may also configure Node₂ and Node₁ to reject data received from Node₄. Rejection of data by Node₂ and Node₁ may force Node₄ to transmit data directly to Node₃.

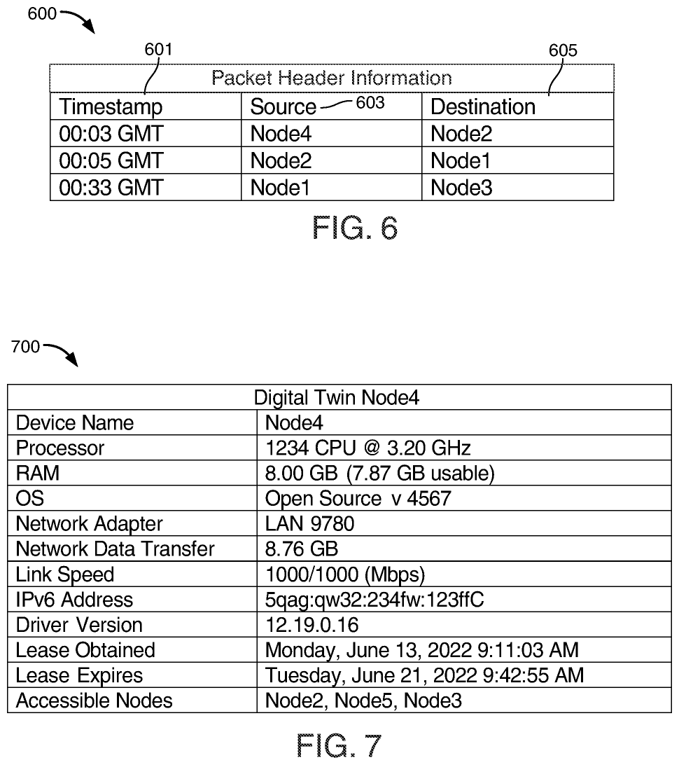

FIG. 6 shows illustrative packet header information 600. An AI simulator may trace data packets by configuring each node that processes a data packet to record a node identifier in a header of the data packet before transmitting the data packet to another node. After the data packet reaches a final destination, the AI simulator may then examine the header and determine a number of nodes and/or edges included in a pathway followed by the data packet through the network. The AI simulator may apply a machine learning algorithm to reduce the number of nodes and/or edges associated with travel of the data packet within the network.

Packet header information 600 shows illustrative information that may be recorded in a packet header. Packet header information 600 includes timestamp 601. Timestamp 601 may indicate when a data packet was received at source node 603. Packet header information 600 includes a destination node 605 for a payload of the data packet.

FIG. 7 shows illustrative information 700 that may be used to build a digital twin of Node₄ (shown in FIG. 4). Information 700 may be obtained based on trace data. Information 700 may be obtained by directly querying Node₄. An AI simulator may amalgamate information shown in FIG. 7 for multiple nodes on a complex network. The AI simulator may apply a machine learning algorithm to the amalgamated information associated with the multiple nodes to construct a digital twin of a complex network.

Thus, methods and apparatus for DIGITAL TWINNING OF LARGE-SCALE NETWORKS are provided. Persons skilled in the art will appreciate that the present disclosure can be practiced by other than the described embodiments, which are presented for purposes of illustration rather than of limitation, and that the present disclosure is limited only by the claims that follow.

What is claimed is:

1. An artificial intelligence (“AI”) method for dynamically rerouting network traffic on a network, the method comprising extracting computer readable instructions stored on a non-transitory medium and executing the computer readable instructions on a processor, wherein execution of the computer readable instructions by the processor:
detects a threshold transmission latency on the network;
increases network traffic by activating data packet tracing;
based on the data packet tracing, identifies a bottleneck within the network;
in response to detecting the bottleneck, simulates a change to the network that alleviates the bottleneck; and
based on the simulated change, implements the change on the network.

2. The AI method of claim 1 wherein execution of the computer readable instructions by the processor detects the bottleneck by identifying a target node on the network that routes a threshold number of data packets within a threshold time window.

3. The AI method of claim 1 wherein execution of the computer readable instructions by the processor detects the threshold transmission latency by:
determining a final destination of a first data packet generated by an edge node on the network;
determining a geodesic network path from the edge node to the final destination;
determining, based on the data packet tracing, whether the first data packet is being routed along the geodesic network path; and
in response to detecting that the first data packet is not being routed along the geodesic network path, imposing a fixed routing pathway for a second data packet generated by the edge node such that the second data packet is transmitted along the geodesic network path.

4. The AI method of claim 2, wherein the change to the network comprises configuring a threshold number of nodes on the network and positioned within a threshold distance of the target node to bypass the target node when transmitting data packets.

5. The AI method of claim 1 wherein execution of the computer readable instructions by the processor simulates the change to the network by simulating bypass of a target node in a digital twin environment.

6. The AI method of claim 1 wherein execution of the computer readable instructions by the processor activates the data packet tracing by inserting an executable header into a target data packet, wherein the executable header transmits a homing signal from each node on the network that routes the target data packet.

7. The AI method of claim 1 wherein execution of the computer readable instructions by the processor builds a digital twin of the network based on the data packet tracing.

8. The AI method of claim 7 wherein execution of the computer readable instructions by the processor:
based on the data packet tracing, detects a hard-coded circuitous routing path;
within the digital twin, simulates deleting the hard-coded circuitous routing path; and
deletes the hard-coded circuitous routing path from at least one node on the network.

9. The AI method of claim 1 wherein the change to the network comprises:
imposing a hard-coded routing path network traffic between two nodes; or
allocating additional computing resources to a target node.

10. An artificial intelligence (“AI”) network traffic simulator comprising computer executable instructions, that when executed by a processor on a computer system:
detect a threshold transmission latency on a network;
increase network traffic by activating data packet tracing on the network;
based on the data packet tracing, detect a circuitous data flow within the network;
in response to detecting the circuitous data flow, simulate a change to the network that alleviates the circuitous data flow; and
based on the simulated change, apply the change on the network and reduce the threshold transmission latency.

11. The AI network simulator of claim 10, wherein the circuitous data flow comprises utilizing a first intermediary node to route data packets generated by a target node, wherein the first intermediary node is geographically further away from the target node than a second intermediary node capable of routing the data packets generated by the target node.

12. The AI network simulator of claim 11, wherein the change to the network forces the second intermediary node to route data packets generated by the target node.

13. The AI network simulator of claim 10, the computer executable instructions, when executed by the processor on the computer system:
based on the data packet tracing, builds a digital twin of the network;
on the digital twin, simulates the change to the network that alleviates the circuitous data flow; and
based on a response of the digital twin to the simulated change, deploys the change on the network.

14. The AI network simulator of claim 10 the computer executable instructions, when executed by the processor on the computer system deploy the change on the network by changing a routing configuration setting of at least one edge node on the network.

15. The AI network simulator of claim 10 the computer executable instructions, when executed by the processor on the computer system activates data packet tracing by:
decrypting a target data packet at each node that transmits the target data packet; and
records a location of each node that routes the target data packet.

16. The AI network simulator of claim 10 the computer executable instructions, when executed by the processor on the computer system activates data packet tracing by configuring each node that processes a target data packet to record an identifier of each node in a header of the target data packet before transmitting the target data packet.

17. An artificial intelligence (“AI”) network traffic simulator comprising computer executable instructions, that when executed by a processor on a computer system:
trace a flow of data within a network;
based on the flow of data, build a digital twin of the network;
simulate, within the digital twin, an alternative data routing pathway; and
configure the network to implement the alternative data routing pathway.

18. The AI network traffic simulator of claim 17, the computer executable instructions, when executed by the processor on a computer system trace the flow of data through the network by recording, in a header of a target data packet:
an identifier of a forwarding node on the network that processes the target data packet;
a timestamp when the forwarding node received the target data packet; and
a destination node for the target data packet.

19. The AI network traffic simulator of claim 17, the computer executable instructions, when executed by the processor on a computer system:
based on the flow of data, determine a first sequence of nodes that process a threshold number of data packets; and
the alternative data routing pathway comprises a second sequence of nodes.

20. The AI network traffic simulator of claim 17 wherein the alternative data routing pathway forces a target data packet to be processed by a first node within a threshold geographic distance of a second node that generated the target data packet.
